(19) United States
(12) Patent Application Publication
(10) Pub. No.: US 2006/0059488 A1
(43) Pub. Date: Mar. 16, 2006

(54) Task confirmation method

(75) Inventor: Chia-Hsiang Lin, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/222,269

(22) Filed: Sep. 8, 2005

(30) Foreign Application Priority Data
Sep. 10, 2004 (TW) 093127562

(51) Int. Cl. G06F 9/46

(52) U.S. Cl. 718/100

(57) ABSTRACT

A task confirmation method is used in a task executing apparatus. A scheduled task is going to be executed by the task executing apparatus at a preset time point. After the scheduling operation, whether conditions of the task executing apparatus are ready for executing the scheduled task at the preset time point are checked in response to a power-off signal of the task executing apparatus and/or an awaking signal for waking up the powered-off task executing apparatus. If the conditions of the task executing apparatus are not ready for executing the scheduled task at the preset time point, a warning message will be outputted.

### FIELD OF THE INVENTION

The present invention relates to a task confirmation method, and more particularly to a task confirmation method for securing a scheduled task of a task executing apparatus, e.g. scheduled recording of a digital recording/reproducing apparatus.

### BACKGROUND OF THE INVENTION

A digital recording/reproducing apparatus, for example a DVD recorder, is used to record video data into a recordable disc or reproduce video data from a readable disc. Referring to FIG. 1, a functional block diagram of a typical DVD recorder is shown. Nowadays, the DVD recorder 10 can be used with various kinds of electrical appliances to record video data from various sources. For example, the analog video signals received from the TV tuner 11 are transmitted to the control circuit 16 to be converted into digital data in a specified format such as MPEG. The digital data in the MPEG format are then recorded into a recordable disc 15 loaded in the disc burner 17 of the DVD recorder 10. Likewise, the analog video signals received from the video cassette recorder (VCR) 12, the DVD player 13, or the digital video signals received from the digital video (DV) camera 14 can also be converted into digital data in a specified format such as MPEG by the control circuit 16 to be recorded into the recordable disc 15.

Referring to FIG. 2, a functional block diagram of another DVD recorder is shown. The DVD recorder 100 comprises a disc burner 102, a control circuit 106, and a digital data storage device such as a hard disc drive 101. The signals received from the TV tuner 11, the VCR 12, the DVD player 13, or the DV camera 14 are firstly converted into digital data in a specified format such as MPEG by the control circuit 106. The MPEG digital data are then stored in the hard disc drive 101 in an editable manner. The edited digital data is then recorded into the recordable disc 15 by the disc burner 102. On the other hand, it is also possible to record the data previously stored in the disc 15 into the hard disc drive 101.

Either of the DVD recorders mentioned above may exhibit a scheduled recording function, as illustrated in the flowchart of FIG. 3. That is, via a user's interface, the DVD recorder can be previously set to start a recording operation at designated time. Once the setting is done, the DVD recorder will check whether the current conditions are ready for the scheduled recording program automatically. For example, whether the spare space in a hard disc drive or a recordable optical disc is sufficient for the recording, whether a recordable disc is properly positioned inside the DVD recorder, and whether the signal transmission is stable enough are checked. If there is any factor that leads to the possible failure of the scheduled task, a warning message will pop out to show the unsatisfactory factor so that the user can make it up accordingly. Once every condition for scheduled recording has been satisfied, the scheduling operation completes.

Conventionally, there will be no further check after the scheduling operation has completed. Once any recording-essential condition of the DVD recorder is changed after the scheduling operation, the scheduled recording may fail. For example, in a case that a recording is scheduled at 8:00 am to start at 12:00 midnight, the DVD recorder should be powered off after completing the scheduling operation and will be automatically powered on to perform the recording at 12:00 midnight. Before the scheduled recording operation is performed, if the DVD recorder is powered on for another recording operation by another user unconscious of the existing recording schedule, the spare space of the hard disc drive or recordable optical disc supposed to be reserved for the previously scheduled recording might become insufficient. Consequently, the previously scheduled recording operation would fail. The previously scheduled recording operation would also fail if the recordable optical disc to be used for the previously scheduled recording is replaced by a read-only optical disc for another playback operation. Or the user may perform another recording operation improvisatorially that left insufficient resources for the originally scheduled recording task. There could still be various adverse situations occurring to ruin the scheduled task after the scheduling operation.

### SUMMARY OF THE INVENTION

Therefore, the present invention provides a task confirmation method that will check the conditions of the DVD recorder before the scheduled recording operation is performed. The present invention further provides a task confirmation method that repeatedly checks the conditions of the DVD recorder for scheduled recording.

According to an aspect of the present invention, a task confirmation method for use in a task executing apparatus is explained. According to the disclosed method, the conditions of the task executing apparatus are checked to see whether they are ready for executing a scheduled task at a preset time point in response to a power-off signal of the task executing apparatus. A warning message is output when the conditions of the task executing apparatus are not ready for executing the scheduled task at the preset time point.

In an embodiment, the method further includes a step of entering the task executing apparatus into a standby state if the conditions of the task executing apparatus are ready for executing the scheduled task at the preset time point. The conditions of the task executing apparatus are checked to see whether they are ready for executing the scheduled task at the preset time point in response to an awaking signal for waking up the task executing apparatus from the standby state.

For example, the preset time point can be a preset clock time or a certain period of time from a reference time. In an embodiment, the awaking signal can be repetitively issued at a certain interval. Alternatively, the awaking signal can also be repetitively issued at a certain interval until the conditions of the task executing apparatus checked in response to the awaking signal are ready for executing the scheduled task.

In an embodiment, the method further includes a step of entering the task executing apparatus into a standby state if the conditions of the task executing apparatus are ready for executing the scheduled task at the preset time point. The conditions of the task executing apparatus are checked to see whether they are ready for executing the scheduled task at the preset time point when the task executing apparatus is switched on after the power-off signal.

In an embodiment, the warning message is continuously or intermittently outputted until the conditions of the task executing apparatus are ready for executing the scheduled task at the preset time point. Alternatively, the warning message is outputted for a predetermined period of time. The method could further include a step of entering the task executing apparatus into a standby state after the predetermined period of time for outputting the warning message is due. And the conditions of the task executing apparatus are checked to see whether they are ready for executing the scheduled task at the preset time point again in response to an awaking signal for waking up the task executing apparatus from the standby state.

According to another aspect of the present invention, a task confirmation method for use in a task executing apparatus is disclosed and includes steps of: checking whether conditions of the task executing apparatus are ready for executing a scheduled task at a preset time point in response to an awaking signal for waking up the task executing apparatus from a standby state; and outputting a warning message when the conditions of the task executing apparatus are not ready for executing the scheduled task at the preset time point.

In an embodiment, the method further includes a step of entering the task executing apparatus into a standby state if the conditions of the task executing apparatus are ready for executing the scheduled task at the preset time point. The conditions of the task executing apparatus are checked to see whether they are ready for executing the scheduled task at the preset time point in response to a power-off signal of the task executing apparatus.

According to a further aspect of the present invention, a task confirmation method for use in a task executing apparatus includes steps of: checking whether conditions of the task executing apparatus are ready for executing a scheduled task at a preset time point in response to a power-off signal of the task executing apparatus; entering the task executing apparatus into a standby state if the conditions of the task executing apparatus are ready for executing the scheduled task at the preset time point; checking whether the conditions of the task executing apparatus are ready for executing the scheduled task at the preset time point before the preset time point for executing the scheduled task; and outputting a warning message when the conditions of the task executing apparatus are not ready for executing the scheduled task at the preset time point.

In an embodiment, an awaking signal is issued before the preset time point for executing the scheduled task for waking up the task executing apparatus from the standby state to check whether the conditions of the task executing apparatus are ready for executing the scheduled task at the preset time point.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram illustrating the use of a conventional digital recording/reproducing apparatus with a plurality of external data sources;

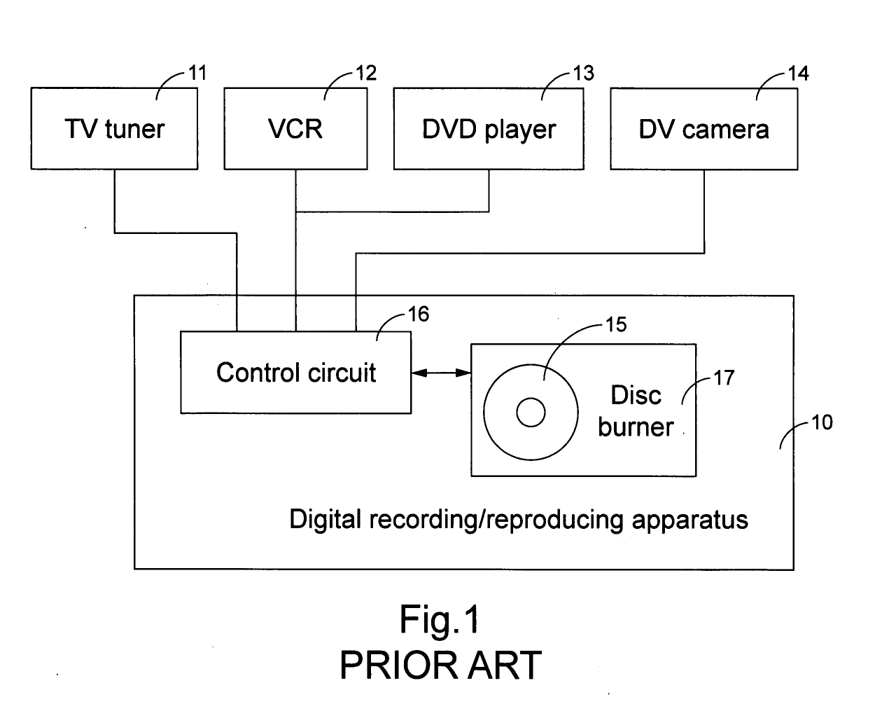

FIG. 2 is a functional block diagram illustrating the use of another conventional digital recording/reproducing apparatus with a plurality of external data sources;

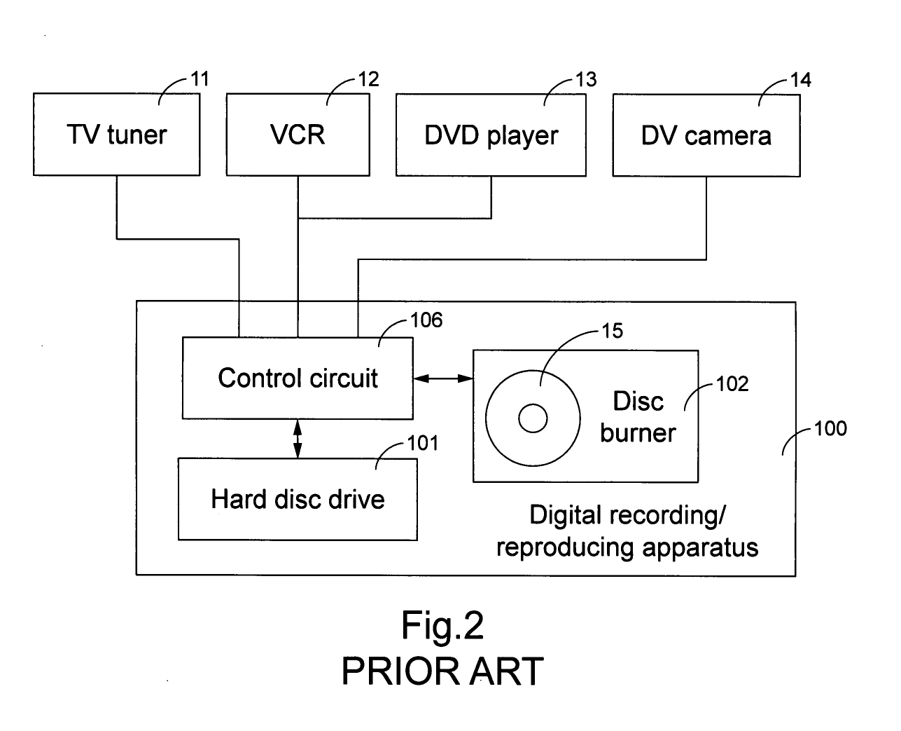

FIG. 3 is a flowchart illustrating a conventional method for scheduling a recording operation;

FIG. 4A is a flowchart illustrating a method for securing a scheduled recording operation according to a first embodiment of the present invention;

FIG. 4B is a flowchart illustrating a method for securing a scheduled recording operation according to a second embodiment of the present invention;

FIG. 5 is a flowchart illustrating a method for securing a scheduled recording operation according to a third embodiment of the present invention; and

FIG. 6 is a flowchart illustrating a method for securing a scheduled recording operation according to a forth embodiment of the present invention.

### DETAILED DESCRIPTION OF THE PREFERRED EMBODIMENT

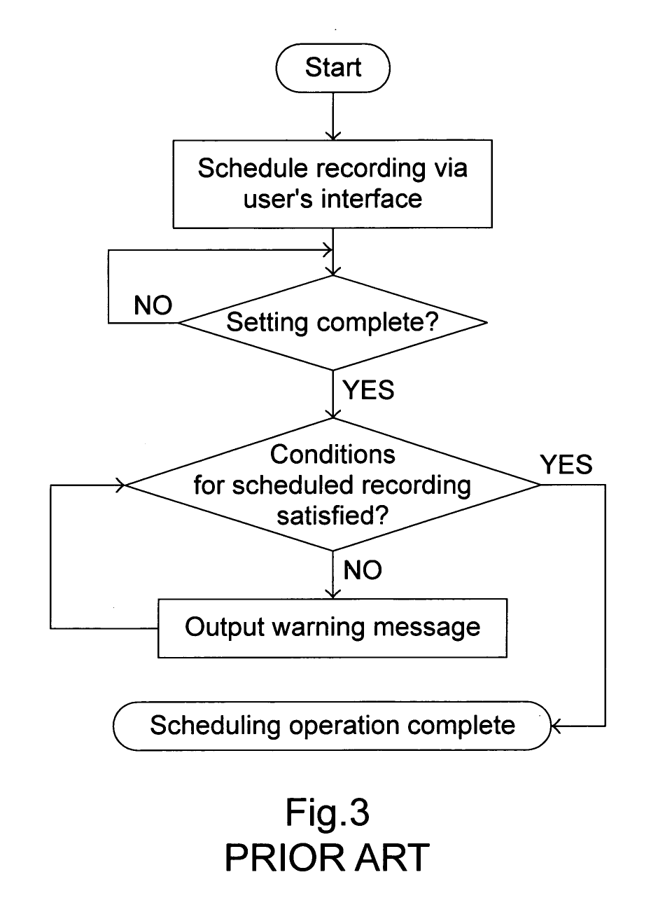

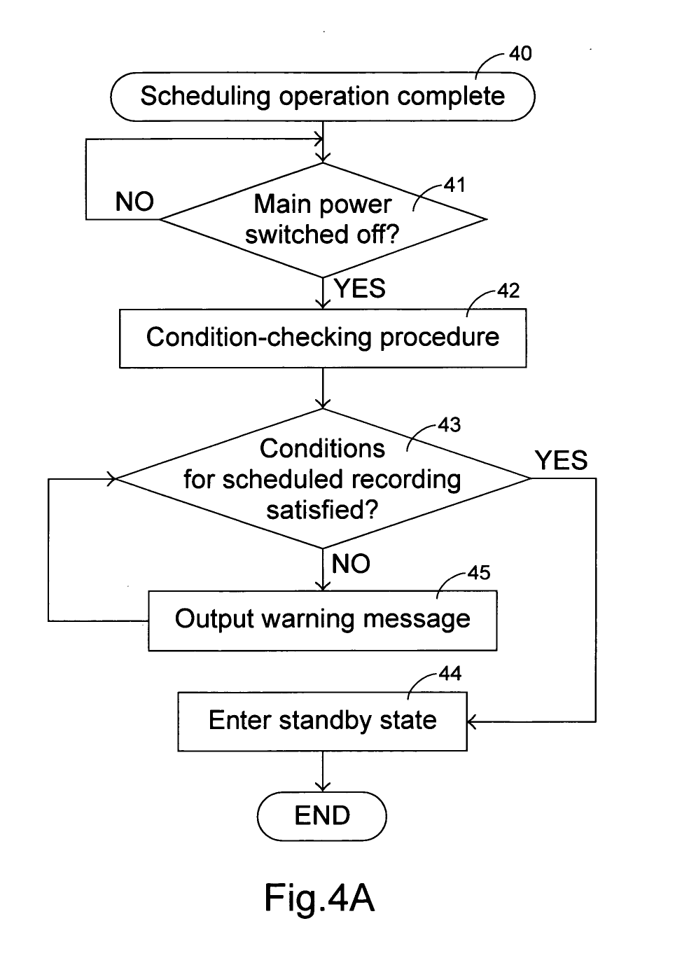

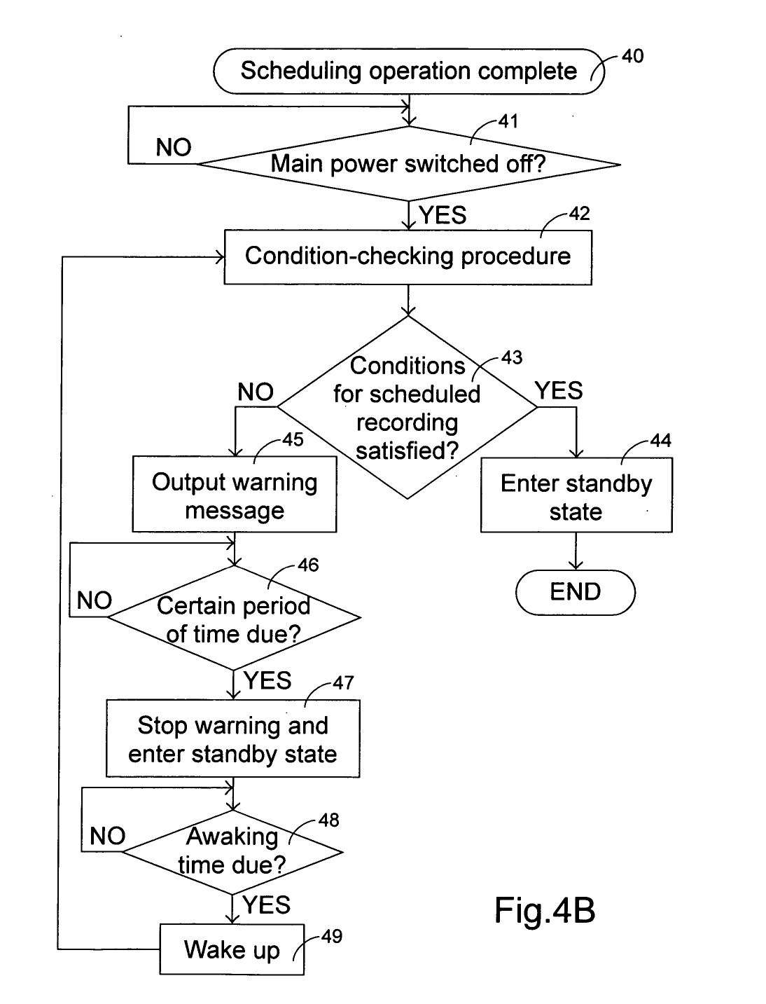

As described above with reference to FIG. 3, a scheduling operation is performed for setting time for starting one or more scheduled recording operations, and the conditions of the DVD recorder for the scheduled recording(s) are checked to see whether the scheduled recording(s) can be well supported. For example, whether the spare space in a hard disc drive or a recordable optical disc is sufficient for the recording(s), whether a recordable disc is properly positioned inside the DVD recorder, and whether the signal transmission is stable enough are checked. When everything associated with the scheduled recording(s) is settled, the user may switch the main power of the DVD recorder off to enter a standby state. However, after the scheduling operation, the user may still use the DVD recorder instead of powering it off immediately. Therefore, according to an embodiment of the present invention, which is illustrated herein as a flowchart of FIG. 4A or 4B, the conditions of the DVD recorder for the scheduled recording(s) are checked again (Step 42) after the scheduling operation has completed (Step 40) and in response to a power-off signal when the user switches main power of the DVD recorder off (Step 41). If all the conditions for the scheduled recording(s) are satisfied (Step 43), the DVD recorder suitably enters the standby state (Step 44). On the other hand, if there is any unsatisfied factor (Step 43), a warning message will pop out to show the unsatisfactory factor (Step 45) so that the user can make it up accordingly. The warning message may be outputted continuously or intermittently until the conditions for next scheduled recording or all the rest scheduled recordings have been satisfied (FIG. 4A). Alternatively, the warning message may just be revealed for a certain period of time and then the DVD recorder enters the standby state (Steps 46 and 47, FIG. 4B).

In the embodiment of FIG. 4B, the warning message stops after the certain period of time is due for avoiding too much noise, light, and power consumption. In order to achieve the task confirmation purpose, however, it is preferred that the condition-checking procedure is performed again if the conditions have not been improved in last checking procedure. Therefore, preset or adjustable awaking time is used to wake the DVD recorder up (Steps 48 and 49) for further condition check (Step 43) until the conditions for next scheduled recording or all the rest scheduled recordings have been satisfied. The preset or adjustable awaking time can be set as a time period for waking the DVD recorder up after the previous checking procedure or preset time points allowing one or more chances to check the conditions before the next scheduled recording task. Moreover, the condition-checking procedure and the following steps as shown in FIGS. 4A and 4B can also be performed automatically to exam the resources for remaining scheduled tasks whenever the DVD recorder is switched on again by the users.

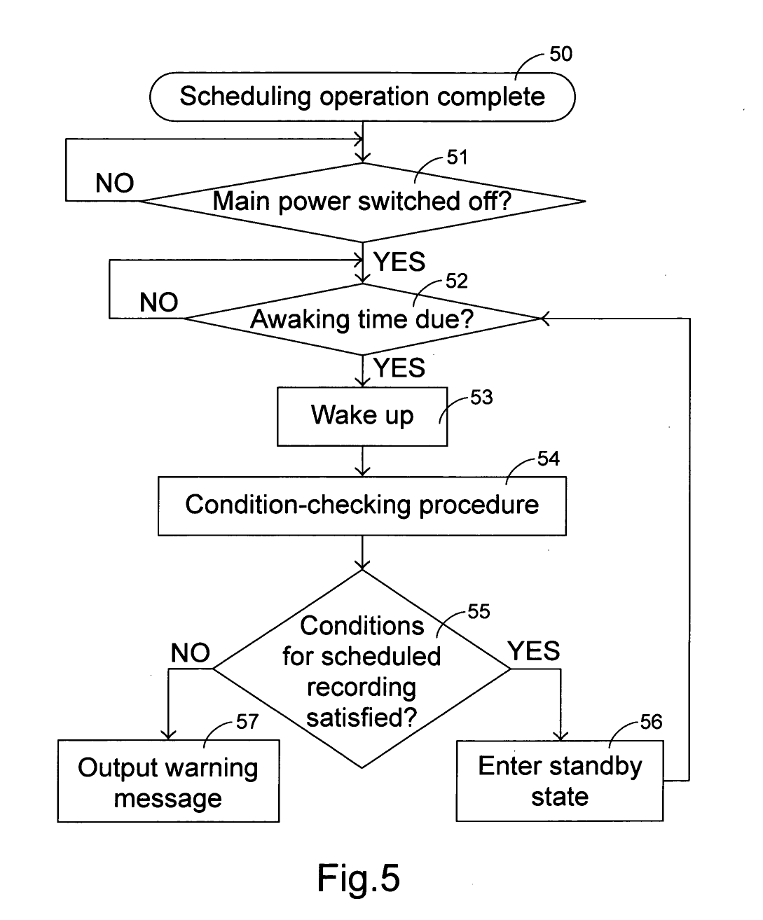

In another embodiment illustrated in the flowchart of FIG. 5, after the scheduling operation as illustrated in FIG. 3 has completed (Step 50) and the user switches the main power of the DVD recorder off (Step 51), preset or adjustable awaking time is tracked (Step 52). When the awaking time is due, the DVD recorder is waked up (Step 53) to perform the condition-checking procedure again (Step 54). The preset or adjustable awaking time can be set as a time interval for waking the DVD recorder up at a certain interval or preset time points allowing one or more chances to check the conditions before the scheduled recording task. If all the conditions for the scheduled recording(s) are satisfied (Step 55), the DVD recorder suitably enters the standby state (Step 56). On the other hand, if there is any unsatisfied factor (Step 55), a warning message will pop out to show the unsatisfactory reason (Step 57) so that the user can make it up accordingly.

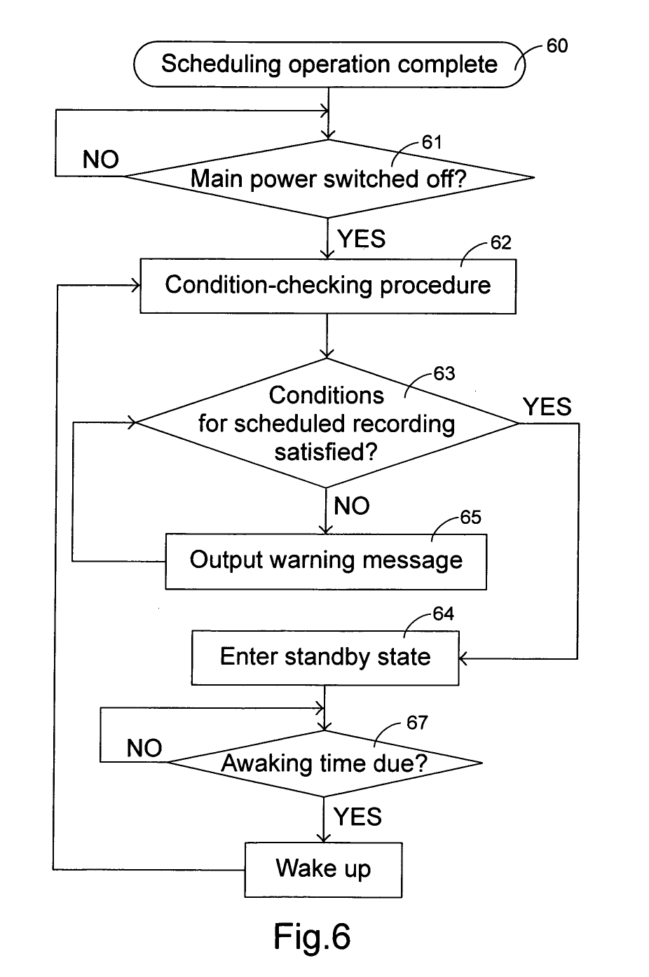

Of course, steps similar to Steps 41˜45 may be optionally combined with the above procedures for provide immediate check after the recorder is switched off. In a further embodiment illustrated in the flowchart of FIG. 6, the conditions for the scheduled recording(s) are double checked after the scheduling operation of FIG. 3. First of all, Steps 60˜65 similar to Steps 40˜45 of FIG. 4A are performed to ensure conditions satisfying the scheduled recording(s) before the DVD recorder enters the standby state. Then, the conditions for the scheduled recording(s) are checked again by waking the DVD recorder up for the checking procedure ahead of the designated time for starting next recording. In this embodiment, as long as the scheduled recording time has not been due, preset, or adjustable awaking time can be used to repetitively wake the DVD recorder up (Steps 67 and 68) for more than one checking procedures. The preset or adjustable awaking time can be set as a time period for waking the DVD recorder up at a certain interval or preset time points allowing one or more chances to check the conditions before the scheduled recording task. Alternatively, the waking operations can be performed until the conditions for the scheduled recording(s) are satisfied. If all the conditions for the scheduled recording(s) are satisfied (Step 63), the DVD recorder suitably enters the standby state (Step 64). On the other hand, if there is any unready factor (Step 63), a warning message will pop out to show the unsatisfactory factor (Step 65). In this embodiment, the warning message is outputted continuously until the conditions for next scheduled recording or all the rest scheduled recordings have been satisfied. Alternatively, the warning message may just be revealed for a certain period of time or outputted intermittently.

The warning message in any of the above embodiments can be revealed in a variety of forms. For example, it can be a literal message shown on a display, a voice message outputted by a speaker, or other visible or audible signals outputted by a light emitting diode, buzzer, etc. Further, the scheduled recording time as well as other time point for performing the condition-checking procedure can be set as clock time or a certain time period from a reference time, e.g. 10:00 pm or 8 hours later from current time, depending on designs of the DVD recorders. Though a DVD recorded is exemplified for illustrating the task confirmation method according to the present invention, the present method can also be applied to any other digital recording/reproducing apparatus and any other suitable task executing apparatus, and particularly useful for the task executing apparatus to execute one or more scheduled tasks on time

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A task confirmation method for use in a task executing apparatus, comprising steps of:
checking whether conditions of the task executing apparatus are ready for executing a scheduled task at a preset time point in response to a power-off signal of the task executing apparatus; and
outputting a warning message when said conditions of the task executing apparatus are not ready for executing said scheduled task at said preset time point.

2. The method according to claim 1 further comprising steps of:
entering the task executing apparatus into a standby state if said conditions of the task executing apparatus are ready for executing said scheduled task at said preset time point; and
checking whether said conditions of the task executing apparatus are ready for executing said scheduled task at said preset time point in response to an awaking signal for waking up the task executing apparatus from said standby state.

3. The method according to claim 1, wherein said preset time point is a preset clock time or a certain period of time from a reference time.

4. The method according to claim 2, wherein said awaking signal is repetitively issued at a certain interval.

5. The method according to claim 2, wherein said awaking signal is repetitively issued at a certain interval until said conditions of the task executing apparatus checked in response to said awaking signal are ready for executing said scheduled task.

6. The method according to claim 1 further comprising steps of:
entering the task executing apparatus into a standby state if said conditions of the task executing apparatus are ready for executing said scheduled task at said preset time point; and
checking whether said conditions of the task executing apparatus are ready for executing said scheduled task when said task executing apparatus recorder is switched on after said power-off signal.

7. The method according to claim 1, wherein said warning message is continuously or intermittently outputted until said conditions of the task executing apparatus are ready for executing said scheduled task at said preset time point.

8. The method according to claim 1, wherein said warning message is outputted for a predetermined period of time.

9. The method according to claim 8 further comprising steps of:
entering the task executing apparatus into a standby state after said predetermined period of time for outputting said warning message is due; and
checking whether said conditions of the task executing apparatus are ready for executing said scheduled task at said preset time point in response to an awaking signal for waking up the task executing apparatus from said standby state.

10. A task confirmation method for use in a task executing apparatus, comprising steps of:
checking whether conditions of the task executing apparatus are ready for executing a scheduled task at a preset time point in response to an awaking signal for waking up the task executing apparatus from a standby state; and
outputting a warning message when said conditions of the task executing apparatus are not ready for executing said scheduled task at said preset time point.

11. The method according to claim 10 further comprising steps of:
entering the task executing apparatus into a standby state if said conditions of the task executing apparatus are ready for executing said scheduled task at said preset time point; and
checking whether said conditions of the task executing apparatus are ready for executing said scheduled task at said preset time point in response to a power-off signal of the task executing apparatus.

12. The method according to claim 10, wherein said preset time point is a preset clock time or a certain period of time from a reference time.

13. The method according to claim 10, wherein said awaking signal is repetitively issued at a certain interval.

14. The method according to claim 10, wherein said awaking signal is repetitively issued at a certain interval until said conditions of the task executing apparatus checked in response to said awaking signal are ready for executing said scheduled task.

15. The method according to claim 10 wherein said warning message is continuously or intermittently outputted until said conditions of the task executing apparatus are ready for executing said scheduled task at said preset time point.

16. The method according to claim 10 further comprising steps of:
entering the task executing apparatus into a standby state if said conditions of the task executing apparatus are ready for executing said scheduled task at said preset time point; and
checking whether said conditions of the task executing apparatus are ready for executing said scheduled task when said task executing apparatus recorder is switched on after said power-off signal.

17. The method according to claim 10 wherein said warning message is outputted for a predetermined period of time.

18. The method according to claim 17 further comprising steps of:
entering the task executing apparatus into a standby state after said predetermined period of time for outputting said warning message is due; and
checking whether said conditions of the task executing apparatus are ready for executing said scheduled task at said preset time point in response to an awaking signal for waking up the task executing apparatus from said standby state.

19. A task confirmation method for use in a task executing apparatus, comprising steps of:
checking whether conditions of said task executing apparatus are ready for executing a scheduled task at a preset time point in response to a power-off signal of said task executing apparatus;
entering said task executing apparatus into a standby state if said conditions of said task executing apparatus are ready for executing said scheduled task at said preset time point;
checking whether said conditions of said task executing apparatus are ready for executing said scheduled task at said preset time point before said preset time point for executing said scheduled task; and
outputting a warning message when said conditions of said task executing apparatus are not ready for executing said scheduled task at said preset time point.

20. The method according to claim 19, wherein an awaking signal is issued before said preset time point for executing said scheduled task for waking up said task executing apparatus from said standby state to check whether said conditions of said task executing apparatus are ready for executing said scheduled task at said preset time point.
